(19) United States
(12) Patent Application Publication
(10) Pub. No.: US 2015/0093548 A1
(43) Pub. Date: Apr. 2, 2015

(54) PROTECTIVE MAT WITH BOTTOM SURFACE HAVING ENHANCED COEFFICIENT OF FRICTION

(71) Applicant: Edward S. Robbins, III, Muscle Shoals, AL (US)

(72) Inventors: Edward S. Robbins, III, Muscle Shoals, AL (US); Milton F. Bain, JR., Muscle Shoals, AL (US)

(21) Appl. No.: 14/500,237

(22) Filed: Sep. 29, 2014

Related U.S. Application Data
(60) Provisional application No. 61/884,329, filed on Sep. 30, 2013.

(51) Int. Cl. B32B 27/08; B32B 3/08

(52) U.S. Cl. CPC B32B 27/08; B32B 3/085; B32B 2250/02; B32B 2307/744; B32B 2375/00; B32B 2331/04; B32B 2398/20; B32B 2471/04; B32B 2475/00
USPC 428/189; 428/332; 428/339; 428/195.1; 428/213

(57) ABSTRACT

A mat is provided for use on a carpeted floor surface, a hard floor surface, or both, and can have a substantially planar upper body surface suitable for interaction with a chair or other support structure. A slip-resistant layer can be bonded to a substantially planar lower body surface of the mat. The slip-resistant layer can be in the form of strips or coextensive with the entire lower body surface. The slip-resistant layer can allow placement in applications requiring simultaneous placement on both carpeted and hard floor surfaces, yet facilitating stable placement on both surfaces.

### PRIORITY

This application claims the benefit of priority of U.S. Provisional Patent Application No. 61/884,329, filed Sep. 30, 2013, which is incorporated herein by reference in its entirety.

### BACKGROUND

1. Field of the Invention

This invention generally relates to protective mats, and particularly to chair and floor mats used in the office and home to cover selected areas of carpeting and/or bare flooring having an anti-slippage means.

2. Background of the Invention

Floor mats and chair mats, for office and home use are well known and typically used on hard flooring and/or carpeted flooring. Floor mats are often used in high traffic areas to protect the underlying flooring. Likewise chair mats are typically used to reduce the impact and wear that can be caused by the chair rollers on the supporting chair spider. With both floor mats and chair mats it is desirable that any movement between the mat and the underlying flooring caused by the activity occurring on the upper surface of the mat be minimized. Floor mats and chair mats can include an array of short point-like protrusions on an underside surface of the mat, that are intended to hold the mat firmly in place on carpet, but such protrusions do not interact sufficiently with hard flooring to prevent movement of the mat. This is because of the lack of penetration of the protrusions into the hard flooring and the reduced surface area contact between the chair mat and the floor. Mats can also be made without any protrusions, which increases the surface area contact between the mat and the hard floor, which as a general rule aids in preventing slippage. The mats without protrusions perform less well with carpeted flooring. Some large area mats, and particularly runners, have included an adhesive coating on a lower surface to enhance the stability of the mat on the carpet, but when removed often leave behind sufficient adhesive on the carpet surface as to significantly increase the later bonding of dirt and grime to the surface of the carpeting.

Therefore, what is needed is a single mat that is capable of being used on hard flooring and/or and carpeted flooring to minimize slippage. It is desirable that these features be incorporated in a single unitary mat having other features that contribute to reduced costs in manufacturing and sufficient anti-slippage.

### SUMMARY

A single unitary mat is provided for use on an underlying surface including a carpeted surface, a hard floor surface, or both. The mat can have a substantially planar upper surface suitable for walking traffic and for interaction with a chair support structure that typically includes a plurality of wheels or casters on the lower outside points of a spider. The mat upper surface can include small variations that reduce the chance for slipping. The mat can include a body, typically made of polyvinyl chloride (PVC), polypropylene, high density polyethylene, polyester copolymers, or polycarbonate, of a variety of thicknesses. When the mat is to be used in an office situation to support a wheeled chair, the thickness of the body can be sufficient to exhibit very little deflection at the points supporting the chair. When the mat is to be used in a high pedestrian traffic area, the body thickness can be reduced to the point that the mat can be easily rolled up for storage between uses. The lower surface of the mat can include a thin coating, not greater than 0.5 mm (0.020 in.), and possibly as little as 0.125 mm (0.005 in.) in thickness, of a polymer selected because of its high static coefficient of friction of at least about 0.50, and preferably 0.60 or higher. The slip-resistant layer can be bonded to the mat lower surface to space at least part of the mat lower surface away from an underlying surface with which the mat is aligned. The slip-resistant layer can be co-extensive with the mat lower surface to facilitate stable placement on any underlying surface. The slip-resistant layer can be formed from a polymer such as ethylene vinyl acetate (EVA) or polyurethane. The slip-resistant layer can be co-extruded with or laminated to the body-forming layer.

One feature of the mat is that the mat can be used on multiple surfaces, such as hard flooring and carpeting flooring, simultaneously or independently, in order to substantially decrease the risk of slippage along the surfaces. Another advantage is that a mat having sufficient anti-slippage can be manufactured less expensively.

The above, as well as other advantages, will become readily apparent to those skilled in the art from the following detailed description of a preferred embodiment when considered in the light of the accompanying drawings.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments.

FIG. 1 is a perspective view of an example chair mat having a slip resistant lower surface.

FIG. 2 is a perspective view of an example runner mat having a slip resistant lower surface.

### DESCRIPTION OF PREFERRED EMBODIMENTS

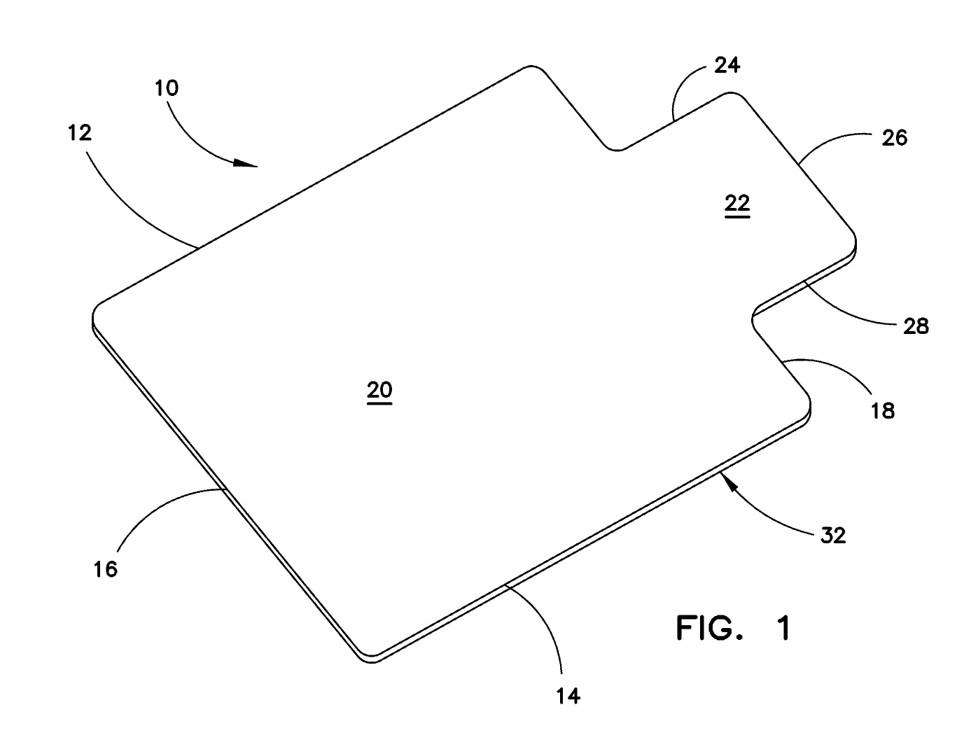

Referring to the drawings, wherein like reference numerals refer to like components, there is shown in FIG. 1 an embodiment of a mat 10 for use on a variety of flooring surfaces. The mat 10 can be formed of a planar, semi-rigid member body 11 having a first side and a second side opposite the first side. The mat 10 may also include four side edges 12, 14, 16 and 18, which define a major portion, or first portion, 20 of the mat 10. An optional extension portion 22 that can be of the same material and thickness as the major portion 20, can project or extend integrally from the side edge 18. The optional portion 22, can be further defined by edges 24, 26, 28, which complete the periphery 30 of the mat 10. The extension 22 is designed to project into the well area of a desk or other work surface, with the remainder of the mat 10 positioned behind the desk and serving as the principal contact area for a chair, such as a desk chair, typically (but not necessarily) fitted with rollers or casters. The mat 10 for purposes of these embodiments, however, need not have an extension 22 of this type. The mat 10 includes a slip resistant layer 32 that can form a lower layer and be coextensive with at least a portion of the mat body 11. The slip resistant layer 32 can be a planar surface that forms a first layer aligned with the mat body 11 forming a second layer such that the first and second layers are in parallel and contiguous. In an embodiment, the slip resistant layer 32 may substantially cover the entirety of a planar surface of one side of the mat body 11, such as a lower surface of the mat body 11. Alternatively, the slip resistant layer 32 may cover less than all of one side of the mat body 11.

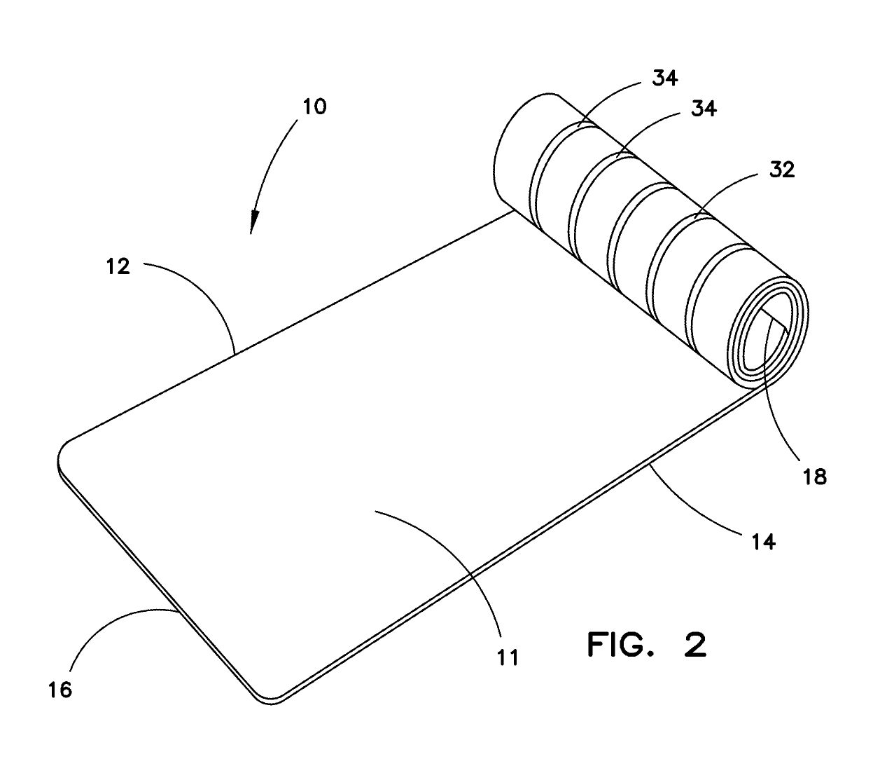

FIG. 2 shows a second embodiment of a mat 10 that can be used as a runner for extended lengths in high traffic areas and the like. The mat 10 includes a body 11 that is sufficiently thin to permit the mat 10 to be rolled up for storage between uses. The body 11 includes two parallel side edges 12, 14 that can be separated from each other by a chosen width of the mat 10, typically between 1 and 2 meters. The length of the body 11 between edges 16 and 18 can be many times the width, for example, 30 meters. The mat 10 includes a slip resistant layer 32 that can be coextensive with the mat body 11 so as to form a planar surface contiguous with the body 11 and extending to the edges of the mat 10 such that the body 11 is maintained separated from underlying floor upon which the mat 10 is aligned. The mat body 11 and the slip resistant layer 32 can form parallel layers coupled at respective planar surfaces. Alternatively, as illustrated in the example embodiment of FIG. 2, the mat 10 can include the slip resistant layer 32 in the form of longitudinal strips 34 that form an additional layer of material on the body 11 with voids being formed between the longitudinal strips 34. Accordingly, in this embodiment, only a portion of the body 11 is maintained as spaced away from the underlying floor upon which the mat 10 is placed. In this example embodiment, the longitudinal strips 34 may extend along the entirety of the body 11, and/or may be aligned into separate longitudinal strips spaced apart and each extending a predetermined distance along a portion of the body 11. In other embodiments, shapes other than longitudinal strips, such as circles, squares, ovals, or triangles, may be used for the slip-resistant layer to separate at least a part of the body 11 away from the underlying floor upon which the mat is aligned.

The material of the mat body 11 can possess various physical characteristics that are adaptive for use and protection of a floor. The material can be selected so that the mat 10 is non-absorbent, water repellent, and not easily affected by changes in temperature or humidity. In addition, the mat 10 can expand and shrink without any curling effect, while being compatible with the other layers in this respect. The material can maintain the mat 10 as a whole in proper shape, i.e. flat, and can resist accidental misshaping. Preferably, the body 11 is continuous and substantially uniform in a thickness dimension. The body 11 can be adapted to formation in uniform thickness, such as by extruding, where uniformity and thickness of the body 11 is not adversely affected by outside influences in the extruding step. The thickness can be between about 0.635 mm (0.025 inch) and about 6.5 mm (0.25 inch). The mat 10 can be washable with, for example, soap and water type cleanser, and can be solvent resistant. With these characteristics in mind, the material can be a thermoplastic material, and, in an embodiment, an easily extrudable thermoplastic material. Exemplary thermoplastic materials include polyvinyl chloride (PVC), high density polyethylene, polycarbonate, polypropylene, polyester copolymers, and polystyrene.

As used herein, “high coefficient of friction” means a coefficient of friction between the mat 10 and an underlying surface, such as a floor, that is sufficient to facilitate stable placement or to substantially resist slippage of the mat 10 relative to the underlying surface when walking on the mat and/or when rolling an occupied desk chair along the mat. Sufficient friction to resist slippage can depend on a variety of factors, including the type of underlying surface, the relative surface area of the mat, raised elements, as well as other environmental factors such as relative humidity and dust. For this reason, a high coefficient of friction is not meant to denote any absolute number or level, but is generally substantially higher than the coefficient of friction between a conventional chair mat and the underlying surface regardless of the surface type. It is desirable that the static coefficient of friction be at least about 0.50 and preferably 0.60 or higher. It is otherwise simply descriptive in principle of the desired characteristic of a suitable material for use as the slip-resistant layer, which has a higher coefficient of friction than the body 11 of the mat 10.

The slip-resistant layer 32 can include high coefficient of friction polymeric materials, such as low durometer polyurethane, or poly vinyl acetate. The slip-resistant layer 32 can be fixedly applied to the body 11 to form a unitary single structure. The body 11 and the slip-resistant layer 32 can be coupled together by, for example, a lamination process, co-extrusion, or any other mechanism or process to fixedly couple the body 11 and the slip-resistance layer 32. Preferably, the slip-resistant layer 32 includes has a low adhesive characteristic in order to avoid the potential of dust or dirt buildup on the slip-resistant layer 32, and includes no adhesive substance that can be subject to dust or dirt. It is to be understood that other polymeric materials having the characteristics of the aforementioned materials may be used without departing from the scope of the disclosure. The slip-resistant layer 32 preferably has a thickness of less than about 0.5 mm (0.020 in.), and possibly as little as 0.125 mm (0.005 in.). The slip-resistant layer in combination with the structural features of the mat can allow placement of the mat for applications requiring simultaneous placement on both carpeted and hard floor surfaces, yet facilitating stable, non slippage, placement on both surfaces. In addition, the combination can facilitate stable, non slippage, placement on either carpeted floor surfaces or hard floor surfaces when independently used thereon.

A method of making the mat 10 to facilitate stable placement on both carpeted and hard floor surfaces is also provided. Steps can include at least one of providing a polymer material for the body of the mat, and affixing a slip-resistant layer material to the surface of the body by a lamination process or by co-extrusion. Other steps for making the mat 10 can be found in U.S. Pat. No. 7,029,743 to Robbins, which is herein incorporated by reference. In addition, other methods, such as spraying the slip-resistant layer material will be apparent to those skilled in the art.

While various embodiments have been described, it will be apparent to those of ordinary skill in the art that many more embodiments and implementations are possible within the scope of the disclosure. Accordingly, the invention is not to be restricted.

1. A mat for use on an underlying surface including at least one of a carpeted surface and a hard floor surface, the mat comprising:
a body comprising a substantially planar upper surface, a perimeter defining an outer edge of the body, and a lower surface substantially parallel to the upper surface, and
a slip-resistant layer bonded to the lower surface of the body, the slip-resistant layer having a thickness not greater than 0.020 inches and having a static coefficient of friction of at least 0.50 to facilitate stable placement of said mat with respect to said underlying surface.

2. The mat of claim 1, wherein the body of the mat further comprises at least one of polyvinyl chloride (PVC), polypropylene, high density polyethylene, polyester copolymers, or polycarbonate.

3. The mat of claim 1, wherein the slip-resistant layer further comprises at least one of ethylene vinyl acetate or polyurethane.

4. The mat of claim 1, wherein the slip-resistant layer has a static coefficient of friction of at least 0.60.

5. The mat of claim 1, wherein the slip-resistant layer is in the form of a series of strips.

6. The mat of claim 5, wherein the series of strips longitudinally extend along the body to form a layer that includes voids between the strips.

7. The mat of claim 1, wherein the slip-resistant layer is coextensive with the mat body.

8. A mat comprising:
a body formed with a predetermined thickness between a first planar surface of the body formed opposite to a second planar surface of the body; and
a slip-resistant layer formed with a predetermined thickness that is less than the predetermined thickness of the body, the slip-resistant layer contiguously coupled in parallel with only one of the first planar surface and the second planar surface such that the body and the slip-resistant layer form a single unitary member for use on an underlying floor comprising at least one of a carpeted floor surface or a hard floor surface;
the slip-resistant layer alignable with the underlying floor to create a static coefficient of friction between the slip resistant layer and the underlying floor of at least 0.50.

9. The mat of claim 8, wherein the body and the slip-resistance layer are coupled by an extrusion process.

10. The mat of claim 8, wherein the body and the slip-resistance layer are coupled by a lamination process.

11. The mat of claim 8, wherein the slip resistant layer comprises a high coefficient of friction polymeric material.

12. The mat of claim 11, where the polymeric material comprises at least one of a polyurethane or a poly vinyl acetate.

13. The mat of claim 8, wherein the static coefficient of friction between the slip-resistant layer and the underlying floor is higher than the static coefficient of friction between the body and the underlying floor.

14. The mat of claim 8, wherein the slip resistant layer separates the body from the underlying floor.

15. The mat of claim 8, wherein the slip resistant layer separates only a portion of the body from the underlying floor.

16. A mat comprising:
a slip-resistant layer formed to include a first planar surface and a second planar surface that is parallel and opposite the first planar surface; and
a body coupled with only the first planar surface of the slip-resistant layer such that the body and the slip-resistant layer are layers formed as a single unitary structure having a thickness, in which a first portion of the thickness is the body and a second portion of the thickness is the slip-resistant layer, the first portion being greater than the second portion; and
wherein the single unitary structure is alignable with an underlying floor to create a static coefficient of friction between second planar surface of the slip-resistant layer and the underlying floor of greater than 0.50.

17. The mat of claim 16, wherein the body comprises at least one of polyvinyl chloride (PVC), polypropylene, high density polyethylene, polyester copolymers, or polycarbonate, and the slip resistant layer comprises at least one of ethylene vinyl acetate or polyurethane.

18. The mat of claim 16, wherein any form of adhesive substance is absent from the second planar surface.

19. The mat of claim 16, wherein the slip-resistant layer is bonded to a lower surface of the body by extrusion of the slip-resistant layer and the body.

20. The mat of claim 16, wherein a thickness between the first planar surface and the second planar surface is not greater than 0.020 inches.
